(19) United States
(12) Patent Application Publication
(10) Pub. No.: US 2026/0001646 A1
(43) Pub. Date: Jan. 1, 2026

(54) PERSONAL AIRCRAFT

(71) Applicant: Ilya Daniel Rosenberg, Mountain View, CA (US)

(72) Inventor: Ilya Daniel Rosenberg, Mountain View, CA (US)

(21) Appl. No.: 19/252,223

(22) Filed: Jun. 27, 2025

Related U.S. Application Data
(60) Provisional application No. 63/665,128, filed on Jun. 27, 2024.

(51) Int. Cl. B64C 29/00; B64C 1/16; B64C 11/00; B64C 39/08; B64D 27/02; B64D 27/31; B64D 27/357

(52) U.S. Cl. CPC B64C 29/0025; B64C 1/16; B64C 11/001; B64C 39/08; B64D 27/026; B64D 27/31; B64D 27/357

(57) ABSTRACT

One variation of an aircraft includes: a fuselage; a set of wings; a set of lift motors integrated into the set of wings; a set of batteries housed within the fuselage and electrically coupled to the set of lift motors; a set of lift propellers mechanically coupled to the set of lift motors; a forward-motion propeller; an engine mechanically coupled to the forward-motion propeller; and a controller. The controller is configured to: supply power to the set of lift motors to actuate the set of lift propellers to drive vertical motion of the aircraft in a take-off state; trigger actuation of the forward-motion propeller via the engine to drive forward motion of the aircraft in a forward-flight state.

### CROSS-REFERENCE TO RELATED APPLICATIONS

This application claims the benefit of U.S. Provisional Application No. 63/665,128, filed on 27 Jun. 2024, which is incorporated in its entirety by this reference.

### TECHNICAL FIELD

This invention relates generally to the field of aerospace and more specifically to a new and useful system for controlling vertical and forward motion of an aircraft in the field of aerospace.

### BRIEF DESCRIPTION OF THE FIGURES

FIG. 1 is a schematic representation of an aircraft;

FIGS. 2A and 2B are schematic representations of the aircraft; and

FIGS. 3A and 3B are schematic representations of the aircraft.

### DESCRIPTION OF THE EMBODIMENTS

The following description of embodiments of the invention is not intended to limit the invention to these embodiments but rather to enable a person skilled in the art to make and use this invention. Variations, configurations, implementations, example implementations, and examples described herein are optional and are not exclusive to the variations, configurations, implementations, example implementations, and examples they describe. The invention described herein can include any and all permutations of these variations, configurations, implementations, example implementations, and examples.

### 1. Aircraft

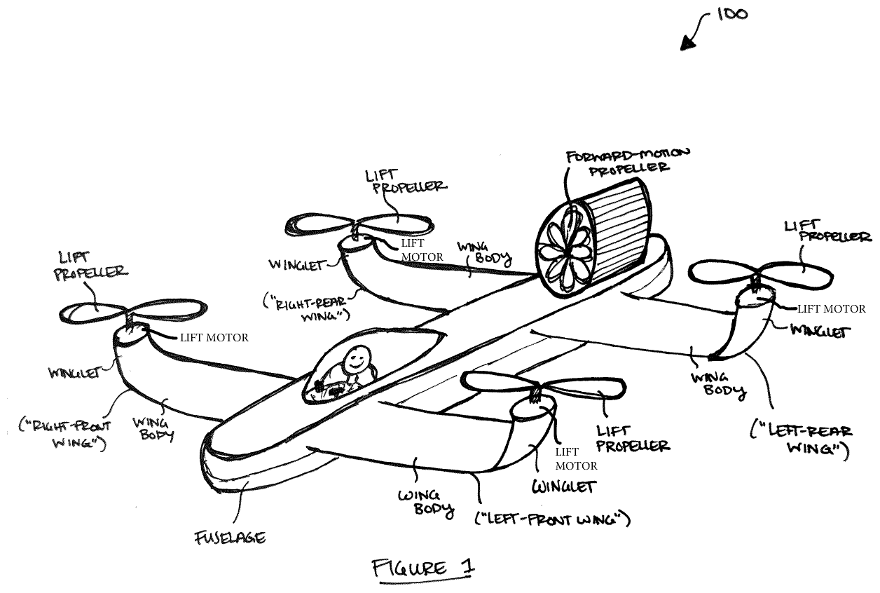

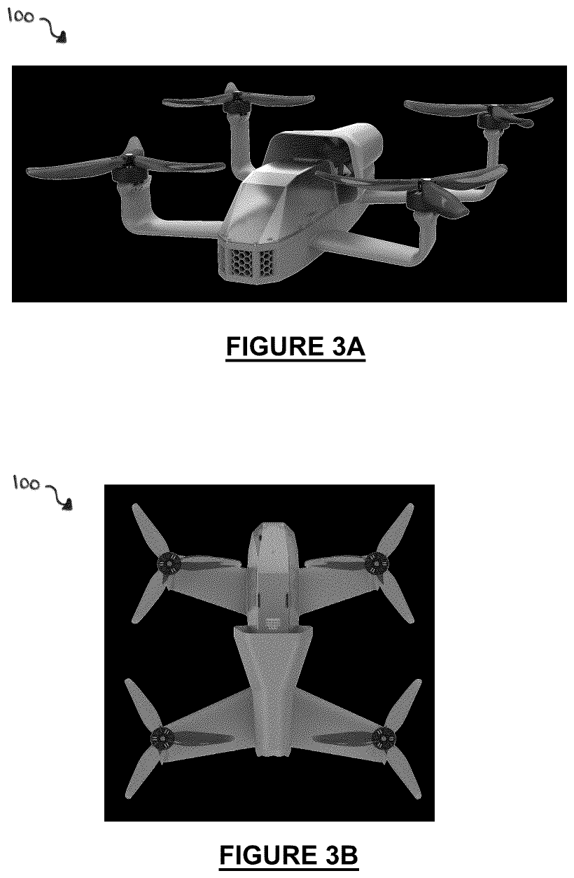

As shown in FIGS. 1, 2A, 2B, 3A, and 3B, an aircraft 100 includes: a fuselage; a set of wings; a set of lift motors (e.g., electric motors) integrated into the set of wings; a set of batteries housed within the fuselage and electrically coupled to the set of lift motors; a set of lift propellers mechanically coupled to the set of lift motors; a forward-motion propeller; an engine mechanically coupled to the forward-motion propeller; and a controller.

The set of wings includes: a left-front wing-extending from a left side of the fuselage at a first height-defining a first wing body coupled to the fuselage at a first proximal end and a first winglet extending upward from the first wing body at a first distal end opposite the first proximal end; a left-rear wing-extending from the left side of the fuselage at a second height exceeding the first height-defining a second wing body coupled to the fuselage at a second proximal end and a second winglet extending upward from the second wing body at a second distal end opposite the second proximal end; a right-front wing-extending from a right side of the fuselage at the first height opposite the left-front wing-defining a third wing body coupled to the fuselage at a third proximal end and a third winglet extending upward from the third wing body at a third distal end opposite the third proximal end; and a right-rear wing-extending from the right side of the fuselage at the second height opposite the left-rear wing-defining a fourth wing body coupled to the fuselage at a fourth proximal end and a fourth winglet extending upward from the fourth wing body at a fourth distal end opposite the fourth proximal end.

The set of lift motors includes: a first lift motor integrated into the first winglet and mechanically coupled to a first lift propeller, in the set of lift propellers, extending outward from the first winglet and arranged in a fixed lift orientation relative the fuselage; a second lift motor integrated into the second winglet and mechanically coupled to a second lift propeller, in the set of lift propellers, extending outward from the second winglet and arranged in the fixed lift orientation relative the fuselage; a third lift motor integrated into the third winglet and mechanically coupled to a third lift propeller, in the set of lift propellers, extending outward from the third winglet and arranged in the fixed lift orientation relative the fuselage; and a fourth lift motor integrated into the second winglet and mechanically coupled to a fourth lift propeller, in the set of lift propellers, extending outward from the fourth winglet and arranged in the fixed lift orientation relative the fuselage.

The forward-motion propeller is mechanically coupled to the engine integrated within the fuselage, extends from a rear of the fuselage, and is arranged in a fixed forward orientation orthogonal the fixed lift orientation of the set of lift propellers.

The controller is configured to: supply power to the set of lift motors to actuate the set of lift propellers to drive vertical motion of the aircraft 100 in a take-off state; trigger actuation of the forward-motion propeller via the engine (e.g., a gas engine, a diesel engine, a jet engine, a hybrid engine) to drive forward motion of the aircraft 100 in a forward-flight state; and reduce power supplied to the set of lift motors to reduce speed of rotation of the set of lift propellers and maintain an elevation of the aircraft 100 within a threshold of the target elevation in the forward-flight state.

### 2. Applications

Generally, the aircraft 100 includes: a fuselage and a set of wings extending outward from the fuselage; a set of lift motors (e.g., electrical motors) integrated into the set of wings—such that each wing, in the set of wings, includes a lift motor integrated into the wing—electrically coupled to a battery supply housed in the fuselage; a set of lift propellers—operable in a fixed “lift” orientation and configured to rotate about a fixed “lift” rotational axis—mechanically coupled to the set of lift motors and configured to transiently drive vertical motion of the aircraft 100; an internal combustion engine (e.g., a gasoline engine, a jet engine, a hybrid engine) integrated within the fuselage; and a forward-motion propeller-operable in a fixed “forward” orientation orthogonal the fixed “lift” orientation and configured to rotate about a fixed “forward” rotational axis orthogonal the “lift” rotational axis—mechanically coupled to the internal combustion engine. The aircraft 100 can also include a local controller configured to: supply power to the set of lift motors via the battery supply to actuate the set of lift propellers and thus drive vertical motion of the aircraft 100; and actuate the forward-motion propeller via the engine to drive forward motion of the aircraft 100. The local controller can therefore separately regulate vertical and forward motion of the aircraft 100 via independent control of the lift and forward-motion propellers.

The local controller can therefore selectively trigger actuation of the set of lift propellers and/or the forward-motion propeller during a take-off state and/or forward-flight state to drive motion of the aircraft 100 in a particular direction (e.g., a vertical direction, a forward direction).

In particular, the local controller can supply power to the set of lift motors to drive actuation of the set of lift propellers, thereby enabling vertical flight of the aircraft 100 during takeoff of the aircraft 100 from the ground. Once the aircraft 100 reaches a target elevation from the ground, the local controller can transition from the take-off state to the forward-flight state and: trigger actuation of the forward-motion propeller via the internal combustion engine (e.g., a gas engine, a diesel engine, a jet engine, a hybrid engine)—mechanically coupled to the forward-motion propeller—to drive forward motion of the aircraft 100 in the forward-flight state; and reduce power supplied to the set of lift motors—via the set of batteries integrated within the set of wings or the fuselage—to reduce a speed of rotation of the set of lift propellers and thus maintain an elevation of the aircraft 100 within a threshold of the target elevation in the forward-flight state.

Therefore, rather than require angular rotation of the set of lift propellers (e.g., propellers on the wings) in order to enable forward and vertical motion of the aircraft 100, the aircraft 100 can include a set of positionally-fixed, lift propellers—configured to solely drive vertical motion of the aircraft 100—and a separate forward-motion propeller configured to solely drive forward motion of the aircraft 100. By thus enabling separate control of vertical motion via the set of lift propellers and forward motion (e.g., lateral motion) via the forward-motion propeller, the aircraft 100 can be configured to reduce a number of moving parts required to enable both vertical and forward motion of the aircraft 100 while reducing complexity in operating and/or navigating the aircraft 100—such as by a human operator (e.g., a pilot)—during takeoff and forward flight.

Furthermore, by separating control of vertical motion (e.g., lift) and forward motion via the set of lift propellers and the forward-motion propeller, the aircraft 100 can minimize a number of moving parts in the wings-such as including a set of identical left wings and a set of identical right wings-thereby minimizing complexity and costs associated with manufacturing the wings. For example, each wing, in the set of wings, can define a relatively low-weight, hollow structure (e.g., a fiberglass structure) configured to house a single lift motor mechanically coupled to a lift propeller at a distal end of the wing.

In one implementation, the aircraft 100 can include: a set of electric lift motors electrically coupled to the battery supply; a liquid-fuel engine arranged within the fuselage and coupled to the forward-motion propeller; a motor generator arranged within the fuselage and coupled to the liquid-fuel engine; and a clutch (e.g., a disc clutch, a cone clutch, a dog clutch) interposed between the forward-motion propeller and the liquid-fuel engine. In this implementation, the local controller can: selectively actuate the liquid-fuel engine and the motor generator—such as operating in a motor state or a generator state—to maintain a minimum battery charge for the set of batteries coupled to and configured to supply electrical power to the set of lift motors; and maximize an efficiency of the liquid-fuel engine given the minimum battery charge defined for the set of batteries. Furthermore, in this implementation, the local controller can selectively disengage the clutch to decouple the liquid fuel engine from the forward-motion propeller—such as responsive to failure of the liquid-fuel engine—in order to transition to exclusively driving the forward-motion propeller with the motor generator in the motor state. In this implementation, the local controller can therefore be configured to maximize a flight duration for a flight—given a limited amount of fuel in the liquid-fuel engine and a limited battery state of charge at a start of the flight—while prioritizing flight safety and enabling continued forward motion of the aircraft 100 regardless of failure of the liquid-fuel engine.

### 3. Wings

Generally, the aircraft 100 includes a set of wings-including a set of left wings and a set of right wings-coupled to and extending outward from the fuselage. In particular, each wing, in the set of wings, can define: a wing body defining a proximal end bolted to the fuselage and a distal end-opposite the proximal end-extending outward from the fuselage; and a winglet extending upward (e.g., vertically upward) from the wing body at the distal end (e.g., opposite the fuselage). The wing body and the winglet can form a unitary structure such that an orientation of the winglet is fixed relative the wing body and relative the fuselage.

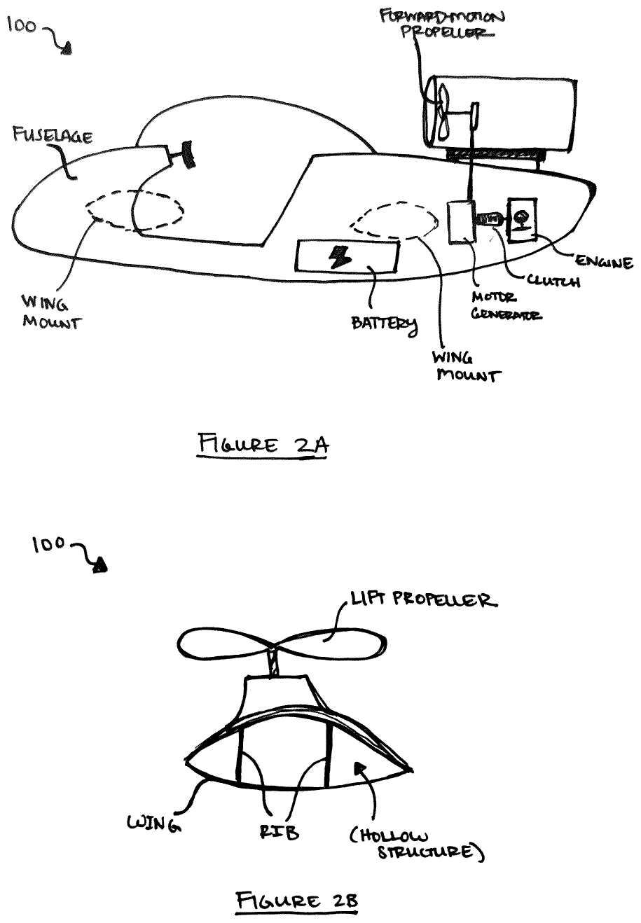

Furthermore, as shown in FIG. 2B, each wing can define a hollow structure exhibiting a relatively low weight and configured to house a battery—configured to supply electrical energy to a lift motor integrated within the winglet—and/or configured to house a set of electrical connections configured to electrically couple the lift motor to the battery arranged within the wing and/or within the fuselage. In one example, the aircraft 100 can include a set of hollow wings formed of a fiberglass material.

In one implementation, the aircraft 100 includes the set of left wings—coupled to and extending from a left side of the fuselage—including a left-front wing and a left-rear wing. Generally, the left-front wing can be mounted to a left side of the fuselage at a first height, such that the left-front wing extends outward from the fuselage at the first height. The left-rear ring can be mounted to the left side of the fuselage at a second height—exceeding the first height—such that the left-rear wing extends outward from the fuselage at the second height. In particular, the left-rear wing can be mounted at the second height exceeding the first height of the left-front wing in order to minimize effects of forces (hereinafter “prop wash”) output behind the left-front wing—generated via actuation of the left-front wing—on operation of the left-rear wing. The fuselage can therefore define a height and a length—extending along a longitudinal axis of the fuselage—such that the left-front wing and the left-rear wing are offset in height and position along the length of the fuselage.

In this implementation, the aircraft 100 also includes a set of right wings—coupled to and extending from a right side of the fuselage—including a right-front wing and a right-rear wing. The right-front wing can be mounted to a right side of the fuselage at the first height, such that the right-front wing extends outward from the fuselage—opposite the left-front wing—at the first height. The right-rear ring can be mounted to the right side of the fuselage at the second height such that the right-rear wing extends outward from the fuselage—opposite the left-rear wing—at the second height. Similarly, the right-rear wing can be mounted at the second height exceeding the first height of the right-front wing in order to minimize effects of prop wash—generated via actuation of the right-front wing—on operation of the right-rear ring.

In this implementation, the left-front wing and the left-rear wing can be substantially identical—characterized by part material, footprint (e.g., size, dimensions), properties, etc.—such that the left-front wing and the left-rear wing can be manufactured according to a single manufacturing or machining process defined for a single part, thereby simplifying manufacturing and reducing costs associated with manufacturing the aircraft 100.

### 3.1 Lift Motors+Propellers

Furthermore, the aircraft 100 can include a set of lift motors integrated into the set of wings and configured to drive vertical motion of the aircraft 100, such as during takeoff and landing of the aircraft 100.

The aircraft 100 also includes a set of lift propellers—each lift propeller, in the set of lift propellers, mechanically coupled to a lift motor in the set of lift motors—configured to direct thrust vertically responsive to actuation via the set of motors. Therefore, each wing of the aircraft 100 can be configured to house a lift motor mechanically coupled to a lift propeller extending from a winglet of the wing. For example, the aircraft 100 can include a set of lift propellers, such as a set of two- or three-blade propellers including fixed-pitch blades.

In particular, in one implementation, the aircraft 100 can include: a first lift motor integrated into a first winglet of a first wing of the aircraft 100; and a first lift propellor—configured to transiently rotate about a first fixed rotational axis—mechanically coupled to the first lift motor and arranged above the first lift motor, extending above the first winglet. In one example, the first lift propeller is mounted to a driveshaft coupled to the first lift motor, such as in the form of a stub axle coupled to an output shaft of the first lift motor or integrated into an external-rotor of the first lift motor. Alternatively, in another example, the first lift propeller can be mounted directly to the output shaft of the first lift motor or to the external-rotor of the first lift motor. The local controller can therefore selectively trigger actuation of the first lift motor to drive rotation of the first lift propellor about the first fixed rotational axis, such as defined by the driveshaft coupled to the first lift motor.

In this implementation, the aircraft 100 can similarly include: a second lift motor integrated into a second winglet of a second wing of the aircraft 100; and a second lift propellor—configured to transiently rotate about a second fixed rotational axis—mechanically coupled to the second lift motor and arranged above the second lift motor, extending above the second winglet. The local controller can therefore selectively trigger actuation of the second lift motor to drive rotation of the second lift propellor about the second fixed rotational axis, such as defined by a driveshaft coupled to the second lift motor.

Additionally, the aircraft 100 can further include: a third lift motor integrated into a third winglet of a third wing of the aircraft 100 and a third lift propellor—arranged above the third lift motor and extending above the third winglet—mechanically coupled to the third lift motor and configured to transiently rotate about a third fixed rotational axis; and a fourth lift motor integrated into a fourth winglet of a fourth wing of the aircraft 100 and a fourth lift propellor-arranged above the fourth lift motor and extending above the fourth winglet-mechanically coupled to the fourth lift motor and configured to transiently rotate about a fourth fixed rotational axis. The local controller can therefore simultaneously trigger actuation of the first, second, third, and fourth lift motors to uniformly drive rotation of the first, second, third, and fourth lift propellors about a corresponding fixed rotational axis, thereby generating at least a minimum vertical thrust configured to enable vertical motion (e.g., upward motion) of the aircraft 100.

Generally, each lift propeller, in the set of lift propellers, can define a fixed rotational axis about which the lift propeller rotates to direct thrust vertically upward. In order to maintain this fixed rotational axis for each lift propeller, in the set of lift propellers, the set of wings—including the set of winglets—and the set of lift motors integrated into the set of winglets can be fixed and/or stationary relative the fuselage, such that the set of motors and the set of lift propellers exhibit no angular rotation and/or change in orientation relative the fuselage.

By thus maintaining the set of lift propellers in a fixed orientation-such that each lift propeller, in the set of lift propellers, is constrained to rotation about a corresponding fixed rotational axis defined by the lift propeller—the set of lift motors and the set of lift propellers can be constrained to drive vertical motion of the aircraft 100, such as independent of forward (e.g., horizontal) motion. The set of lift motors—paired to the set of lift propellers—can therefore be configured to drive vertical motion of the aircraft 100.

The aircraft 100 can also include a set of batteries integrated into the fuselage and/or the set of wings and configured to supply electrical energy to the set of lift motors integrated into the set of winglets. In particular, in one implementation, the aircraft 100 can include a set of lift power systems—each lift power system including a motor controller, a battery, wiring, and/or local control system—configured to selectively drive the set of lift motors, such that each lift motor, in the set of lift motors, is independently controlled by a corresponding lift power system in the set of lift power systems. Additionally, in this implementation, the aircraft 100 can also include a forward power system—including a motor controller, a battery, wiring, and/or local control system—configured to selectively drive the forward-motion propeller, such that the forward-motion propeller is independently controlled by the forward power system.

### 4. Forward-Motion Propeller+Engine

Generally, the aircraft 100 can include a forward-motion propeller (e.g., a pusher propeller, a puller propeller)—such as extending from a rear side or a front side of the fuselage—coupled to an internal combustion engine (e.g., a gas engine, a diesel engine, a jet engine, a hybrid engine) integrated within the fuselage.

The forward-motion propeller can be arranged in a fixed orientation orthogonal the set of lift propellers and configured to rotate about a fixed rotational axis—approximately coaxial the fuselage—orthogonal the set of fixed rotational axes of the set of lift propellers, such that the forward-motion propeller directs thrust in a forward direction orthogonal a vertical direction of thrust output by the set of lift propellers, thereby driving the aircraft 100 in the forward direction.

The internal combustion engine can therefore be configured to actuate the forward-motion propeller to drive forward motion of the aircraft 100 during forward flight, such as succeeding takeoff of the aircraft 100. In particular, the local controller can: trigger actuation of the set of lift motors to drive rotation of the set of lift propellers during take-off and/or landing of the aircraft 100; and trigger actuation of the internal combustion engine to drive rotation of the forward-motion propeller during forward flight of the aircraft 100 succeeding take-off and/or preceding landing of the aircraft 100.

The aircraft 100 can therefore include both the set of lift propellers—coupled to the set of lift motors integrated into the set of winglets—and the forward-motion propeller coupled to the internal combustion engine, thereby enabling separate control of vertical and/or forward motion of the aircraft 100, such as during takeoff, forward flight, and/or landing of the aircraft 100.

### 4.1 Hybrid: Liquid-fuel Engine+Motor Generator

In one variation, the aircraft 100 can include the forward-motion propeller coupled to both a liquid-fuel engine (e.g., a gasoline engine) and a motor generator. In particular, in this variation, the aircraft 100 can include: a liquid-fuel engine-arranged within the fuselage-coupled to the forward-motion propeller and configured to operate on a liquid fuel that exhibits a relatively high energy density, thereby enabling the aircraft 100 to achieve a large payload capacity over an extended flight duration; and a motor generator-arranged within the fuselage-coupled to the liquid-fuel engine and the forward-motion propeller.

The motor generator can be configured to operate in both: a motor state to output a torque and therefore drive rotation of the forward-motion propeller coupled to the motor generator; and a generator state to output electrical energy to charge the set of batteries configured to supply power to the set of lift motors integrated into the set of winglets and mechanically coupled to the set of lift propellors. In particular, the local controller can trigger operation of the motor generator in the generator state in order to recharge the set of batteries during takeoff and/or during forward flight.

The aircraft 100 can therefore include the motor generator—coupled to the forward-motion propeller and the liquid-fuel engine—to enable recharging of the set of batteries that supply electrical energy to the set of lift motors, thereby minimizing risk of a current battery state of charge falling below a minimum or critical battery state of charge during takeoff, flight, and/or landing and thus enabling vertical motion of the aircraft 100 (e.g., for takeoff and/or landing) at any time during a flight.

Furthermore, the aircraft 100 can include the motor generator—configured to selectively output torque on the forward-motion propeller—in order to minimize risk associated with engine failure. In particular, the motor generator can be configured to decouple from the liquid-fuel engine and actuate the forward-motion propeller—independent of the liquid-fuel engine—via battery power responsive to failure of the liquid-fuel engine.

By enabling coupling the forward-motion propeller to both the liquid-fuel engine and the motor generator—operable in both the motor state and the generator state—the aircraft 100 can therefore be configured to maximize a flight duration for a flight given a limited amount of fuel in the liquid-fuel engine and a battery state of charge at a start of the flight. The liquid-fuel engine and the generator motor can thus cooperate to achieve extended flight times, increase lift and payload capacity, high maneuverability, and robust stability control for the aircraft 100.

### 4.1.1 Hybrid Engine+Clutch

In the preceding variation, the aircraft 100 can further include a clutch—such as a cone clutch, a disc clutch, a dog clutch, etc.—interposed between the forward-motion propeller and the liquid-fuel engine. In particular, the aircraft 100 can include: a driveshaft; the forward-motion propeller mounted to the driveshaft; the motor generator coupled to the driveshaft; and the liquid-fuel engine coupled to the motor generator and the forward-motion propeller via the clutch.

The clutch can be interposed between an output shaft of the liquid-fuel engine and the driveshaft and configured to selectively transfer torque between the output shaft of the liquid-fuel engine and the driveshaft. In particular, the clutch is configured to: couple (or “engage”) the output shaft of the liquid-fuel engine to the forward-motion propeller; and decouple (or “disengage”) the output shaft of the liquid-fuel engine from the forward-motion propeller.

For example, the local controller can engage the clutch to couple the output shaft of the liquid-fuel engine to the forward-motion propeller: when the motor generator is actuated to start the engine at the beginning of a flight; and during a flight when the liquid-fuel engine is operated to directly drive the forward-motion propeller. In this example, the local controller can disengage the clutch to decouple the output shaft of the liquid-fuel engine from the forward-motion propeller, such as responsive to failure of the liquid-fuel engine to transition to exclusively driving the forward-motion propeller with the motor generator in the motor state.

In one implementation, the clutch includes a dog clutch. However, the clutch can include a friction clutch (e.g., a single-plate or multi-plate clutch), a conical-spring clutch (or “diaphragm” clutch), or any other type of clutch. In this implementation, the aircraft 100 can include the dog clutch exhibiting no slip, relatively low weight, and high efficiency and configured to transiently engage the output shaft of the liquid-fuel engine via a splined connection, thereby requiring rotation of the output shaft and the driveshaft—mechanically coupled to the forward-motion propeller—at (approximately) identical speeds. The local controller can therefore disengage the dog clutch—via disengagement of the splined connection—to mechanically separate the liquid-fuel engine from the forward-motion propeller responsive to failure of the liquid-fuel engine, thereby enabling continued rotation of the driveshaft and operation of the forward-motion propeller while halting rotation of the output shaft and/or operation of the liquid-fuel engine.

### 5. Scaling: Fuselage Capacity

Generally, the fuselage can define a particular size (e.g., length, width, interior volume) corresponding to a target capacity (or “human occupancy level”) of the aircraft 100.

The aircraft 100 can be configured to define different target capacities (e.g., 1 human, 2 humans, 4 humans) by modifying a size of the fuselage and/or modifying a quantity of wings—and corresponding lift motors integrated into the wings—included in the aircraft 100. In particular, by enabling separate control of vertical motion via the set of lift propellers and forward motion (e.g., lateral motion) via the forward-motion propeller—rather than incorporate propellers that exhibit angular rotation relative the fuselage and thereby drive both vertical and forward motion—the aircraft 100 can minimize a number of moving parts required to enable vertical and forward motion of the aircraft 100, thus reducing complexity in controlling vertical and forward motion of the aircraft 100 and reducing costs and complexity associated with manufacturing the set of wings and/or fuselage of the aircraft 100.

For example, a first instance of the aircraft 100 can define a target capacity of 1, such that the fuselage is configured to house a single seat. In this example, the first instance of the aircraft 100 can include: the fuselage; a set of 4 wings—including a left-front wing, a left-rear wing, a right-front wing, and a right-rear wing—extending outward from the fuselage; a set of 4 lift motors—each lift motor, in the set of 4 lift motors, integrated into a corresponding wing in the set of 4 wings—electrically coupled to a set of batteries housed within the corresponding wing and/or the fuselage; a set of 4 lift propellers, each lift propeller, in the set of 4 lift propellers, mechanically coupled to a corresponding lift motor in the set of 4 lift motors; a single forward-motion propeller—extending from a rear of the aircraft 100 and defining a fixed orientation orthogonal a fixed orientation of the set of 4 lift propellers—mechanically coupled to an internal combustion engine arranged within the fuselage; and a single seat arranged within an interior housing of the fuselage, such as arranged ahead of the forward-motion propeller.

In another example, a second instance of the aircraft 100 can define a target capacity of 2, such that the fuselage is configured to house a set of 2 seats. In this example, the first instance of the aircraft 100 can include: the fuselage; a set of 6 wings—including a set of 3 left-side wings and a set of 3 right-side wings opposite the set of 3 left-side wings—extending outward from the fuselage; a set of 6 lift motors—each lift motor, in the set of 6 lift motors, integrated into a corresponding wing in the set of 6 wings—electrically coupled to a set of batteries housed within the corresponding wing and/or the fuselage; a set of 6 lift propellers, each lift propeller, in the set of 6 lift propellers, mechanically coupled to a corresponding lift motor in the set of 6 lift motors; a single forward-motion propeller—extending from a rear of the aircraft 100 and defining a fixed orientation orthogonal a fixed orientation of the set of 6 lift propellers—mechanically coupled to an internal combustion engine arranged within the fuselage; and a set of two seats arranged within an interior housing of the fuselage arranged ahead of the forward-motion propeller. In this example, the set of two seats can be arranged with a first seat arranged ahead of the second seat (e.g., in a single column)—such that the second seat is interposed between the first seat and the forward-motion propeller—and a length of the fuselage can be increased in order to accommodate the second seat. Alternatively, the set of two seats can be arranged with the first seat in-line with the second seat (e.g., in a single row) and a width of the fuselage can be increased in order to accommodate the second seat.

The aircraft 100 can therefore be configured to include a fuselage of variable size and/or a variable quantity of wings—each including a lift motor mechanically coupled to a lift propeller—without substantially altering operation of the aircraft 100 and/or requiring modifications in manufacturing of the aircraft 100.

### 6. Controls

The aircraft 100 can include a local controller configured to regulate actuation of the set of lift propellers and the forward-motion propeller in order to control vertical and/or forward motion of the aircraft 100.

In particular, the local controller can be arranged in a housing within the fuselage and can cooperate with the set of lift motors and the internal combustion engine—such as including a liquid-fuel engine coupled to a motor generator, as described above—to selectively control operation of the set of lift propellers and the forward-motion propeller during take-off, forward flight, and/or landing of the aircraft 100.

### 6.1 Take-Off+Forward Flight

Generally, the local controller can selectively trigger actuation of the set of lift propellers and/or the forward-motion propeller during a take-off state—corresponding to vertical motion of the aircraft 100 during takeoff and/or landing—and a forward-flight state corresponding to forward motion (and/or vertical motion) of the aircraft 100 during flight, such as succeeding takeoff and/or preceding landing of the aircraft 100.

In particular, in the take-off state, the local controller can supply power to the set of lift motors to drive actuation of the set of lift propellers, thereby enabling vertical flight of the aircraft 100 during takeoff of the aircraft 100 from the ground. Once the aircraft 100 reaches a target elevation from the ground, the local controller can transition from the take-off state to the forward-flight state. In the forward-flight state, the local controller can: trigger actuation of the forward-motion propeller via the internal combustion engine (e.g., a gas engine, a diesel engine, a jet engine, a hybrid engine) mechanically coupled to the forward-motion propeller to drive forward motion of the aircraft 100 in the forward-flight state; and reduce power supplied to the set of lift motors—via the set of batteries integrated within the set of wings or the fuselage—to reduce a speed of rotation of the set of lift propellers and thus maintain an elevation of the aircraft 100 within a threshold of the target elevation in the forward-flight state.

The local controller can therefore: operate the aircraft 100 in the take-off state to regulate vertical motion of the aircraft 100 during takeoff and/or landing via selective actuation of the set of lift propellers; and operate the aircraft 100 in the forward-flight state to regulate forward and/or vertical motion of the aircraft 100 during flight via selective actuation of the forward-motion propeller and the set of lift propellers.

By thus enabling separate control of vertical motion via the set of lift propellers and forward motion (e.g., lateral motion) via the forward-motion propeller, the aircraft 100 can be configured to reduce a number of moving parts required to enable both vertical and forward motion of the aircraft 100 while reducing complexity in operating and/or navigating the aircraft 100—such as by a human operator (e.g., a pilot)—during takeoff and forward flight.

### 6.2 Variation: Battery Charge

In one variation, as described above, the aircraft 100 can include: a liquid-fuel engine arranged within the fuselage and coupled to the forward-motion propeller; and a motor generator arranged within the fuselage and coupled to the liquid-fuel engine.

In this variation, the local controller can be configured to selectively actuate the liquid-fuel engine and the motor generator—such as in the motor state or the generator state—to maintain a minimum battery charge for the set of batteries coupled to and configured to supply electrical power to the set of lift motors integrated into the set of winglets.

In one implementation, the local controller can be configured to selectively actuate the liquid-fuel engine and the motor generator to maintain a minimum battery state of charge corresponding to a flightpath and/or target elevation of the aircraft 100. In particular, in this implementation, the local controller can: access a minimum battery state of charge defined for a current flightpath of the aircraft 100, such as input by an operator prior to a start of a current flight; and selectively actuate the liquid-fuel engine and the motor generator in order to maintain a battery state of charge exceeding the minimum battery state of charge, and thus minimize risk associated with engine failure by ensuring sufficient battery charge remains to safely land the aircraft 100 via electrical power.

For example, for a first flight defining a flight path over open fields (e.g., with minimal trees and/or ground obstructions) with substantial space for landing, the local controller can set the minimum battery state of charge to a relatively low minimum battery state and therefore trigger the motor generator to output torque and a relatively higher rate—rather than conserve and/or generate electrical charge—during forward flight of the aircraft 100. Alternatively, for a second flight defining a flight path over open water—and/or any other ground obstructions (e.g., forests, mountains)—with minimal space for landing, the local controller can set the minimum battery state of charge to a relatively high minimum battery state and therefore trigger the motor generator to output torque at a relatively lower rate—in order to conserve and/or generate electrical charge—during forward flight of the aircraft 100.

### 6.3 Engine Efficiency

In one variation, as described above, the aircraft 100 can include: a liquid-fuel engine arranged within the fuselage and coupled to the forward-motion propeller; and a motor generator arranged within the fuselage and coupled to the liquid-fuel engine. In this variation, the local controller can be configured to selectively actuate the liquid-fuel engine and the motor generator—such as in the motor state or the generator state—to maximize an efficiency of the liquid-fuel engine given the minimum battery charge defined for the set of batteries. The local controller can therefore maintain the engine near a peak operating efficiency over a range of output thrusts while maintaining a minimum state of charge of the set of batteries in order to extend an operating range of the aircraft 100.

In one implementation, the local controller can estimate a current efficiency of the liquid-fuel engine and selectively actuate the liquid-fuel engine and/or motor generator based on this current efficiency in order to drive the current efficiency toward a target efficiency defined for the liquid-fuel engine. For example, during flight of the aircraft 100, the local controller can access an instantaneous torque output of the engine, such as by calculating the instantaneous torque and/or by measuring the current torque output by the engine directly via a torque sensor. The local controller can then: calculate a speed of the engine based on a current speed of the motor generator and a known drive ratio between the engine and the motor generator; retrieve a stored engine efficiency curve for an engine at or near the current engine speed; and query this engine efficiency curve for an estimated efficiency of the engine during the current command cycle based on the current torque output of the engine. In another example, the local controller can pass a current throttle setpoint, the current engine speed, the instantaneous speed of the rotor, and an instantaneous output current of the motor generator (which represents a resistive torque output of the motor generator when the motor generator is regeneratively braking the rotor and an assistive torque output of the motor generator when the motor generator is in the output mode) into a stored engine efficiency model in order to directly estimate the efficiency of the engine during this command cycle.

### 6.4 Engine Failure

Furthermore, in this variation, the local controller can be configured to selectively decouple the liquid-fuel engine from the motor generator responsive to an error in operation of the liquid-fuel engine during flight. For example, the aircraft 100 can include: a driveshaft; the forward-motion propeller mounted to the driveshaft; the motor generator coupled to the driveshaft; and the liquid-fuel engine coupled to the motor generator and the forward-motion propeller via a clutch. The clutch can be interposed between an output shaft of the liquid-fuel engine and the driveshaft and configured to selectively transfer torque between the output shaft of the liquid-fuel engine and the driveshaft. In this example, in response to a fuel supply of the liquid-fuel engine falling below a threshold fuel supply and/or in response to engine failure, the local controller can decouple the liquid-fuel engine from the motor generator via disengagement of the clutch—and therefore halt operation of the liquid-fuel engine—and trigger operation of the motor generator in the motor state to output a torque on the forward-motion propeller.

The systems and methods described herein can be embodied and/or implemented at least in part as a machine configured to receive a computer-readable medium storing computer-readable instructions. The instructions can be executed by computer-executable components integrated with the application, applet, host, server, network, website, communication service, communication interface, hardware/firmware/software elements of a user computer or mobile device, wristband, smartphone, or any suitable combination thereof. Other systems and methods of the embodiment can be embodied and/or implemented at least in part as a machine configured to receive a computer-readable medium storing computer-readable instructions. The instructions can be executed by computer-executable components integrated by computer-executable components integrated with apparatuses and networks of the type described above. The computer-readable medium can be stored on any suitable computer readable media such as RAMs, ROMs, flash memory, EEPROMs, optical devices (CD or DVD), hard drives, floppy drives, or any suitable device. The computer-executable component can be a processor but any suitable dedicated hardware device can (alternatively or additionally) execute the instructions.

As a person skilled in the art will recognize from the previous detailed description and from the figures and claims, modifications and changes can be made to the embodiments of the invention without departing from the scope of this invention as defined in the following claims.

I claim:

1. An aircraft comprising:
a fuselage;
a set of wings comprising:
a left-front wing extending from a left side of the fuselage at a first height and defining:
a first wing body coupled to the fuselage at a first proximal end; and
a first winglet extending upward from the first wing body at a first distal end opposite the first proximal end;
a left-rear wing extending from the left side of the fuselage at a second height exceeding the first height and defining:
a second wing body coupled to the fuselage at a second proximal end; and
a second winglet extending upward from the second wing body at a second distal end opposite the second proximal end;
a right-front wing extending from a right side of the fuselage at the first height opposite the left-front wing and defining:
a third wing body coupled to the fuselage at a third proximal end; and
a third winglet extending upward from the third wing body at a third distal end opposite the third proximal end; and
a right-rear wing extending from the right side of the fuselage at the second height opposite the left-rear wing and defining:
a fourth wing body coupled to the fuselage at a fourth proximal end; and
a fourth winglet extending upward from the fourth wing body at a fourth distal end opposite the fourth proximal end;
a set of lift motors integrated into the set of wings and comprising:
a first lift motor integrated into the first winglet and mechanically coupled to a first lift propeller, in the set of lift propellers, extending outward from the first winglet and arranged in a fixed lift orientation relative the fuselage;
a second lift motor integrated into the second winglet and mechanically coupled to a second lift propeller, in the set of lift propellers, extending outward from the second winglet and arranged in the fixed lift orientation relative the fuselage;
a third lift motor integrated into the third winglet and mechanically coupled to a third lift propeller, in the set of lift propellers, extending outward from the third winglet and arranged in the fixed lift orientation relative the fuselage; and
a fourth lift motor integrated into the second winglet and mechanically coupled to a fourth lift propeller, in the set of lift propellers, extending outward from the fourth winglet and arranged in the fixed lift orientation relative the fuselage;
a set of batteries housed within the fuselage and electrically coupled to the set of lift motors;
a set of lift propellers mechanically coupled to the set of lift motors;
a forward-motion propeller extending from a rear of the fuselage and arranged in a fixed forward orientation orthogonal the fixed lift orientation of the set of lift propellers;
an engine mechanically coupled to the forward-motion propeller and integrated within the fuselage; and
a controller configured to:
supply power to the set of lift motors to actuate the set of lift propellers to drive vertical motion of the aircraft in a take-off state;
trigger actuation of the forward-motion propeller via the engine to drive forward motion of the aircraft in a forward-flight state; and
reduce power supplied to the set of lift motors to reduce speed of rotation of the set of lift propellers and maintain an elevation of the aircraft within a threshold of the target elevation in the forward-flight state.
